(19) United States
(12) Patent Application Publication
(10) Pub. No.: US 2024/0204207 A1
(43) Pub. Date: Jun. 20, 2024

(54) NON-AQUEOUS ELECTROLYTE BATTERY

(71) Applicant: Panasonic Intellectual Property Management Co., Ltd., Osaka (JP)

(72) Inventors: NAOAKI NISHIMURA, Osaka (JP); KYOSUKE OKAZAKI, Osaka (JP); TADAYOSHI TAKAHASHI, Osaka (JP); YOSHIKI SHIMATA, Osaka (JP)

(21) Appl. No.: 18/263,767

(22) PCT Filed: Jan. 26, 2022
(86) PCT No.: PCT/JP2022/002789

§ 371 Date: Aug. 1, 2023

(30) Foreign Application Priority Data
Feb. 12, 2021 (JP) 2021-021215

(51) Int. Cl. H01M 4/80; H01M 4/02; H01M 4/06; H01M 4/50

(52) U.S. Cl. CPC H01M 4/806; H01M 4/06; H01M 4/50; H01M 2004/028

(57) ABSTRACT

A non-aqueous electrolyte battery includes a positive electrode, a negative electrode, a separator between the positive electrode and the negative electrode, and a non-aqueous electrolyte. The positive electrode includes a positive electrode active material and an expanded metal. The expanded metal includes a frame portion constituting meshes. The frame portion includes strands and bonds connecting the strands to one another. The frame portion includes strands and bonds connecting the strands to one another. Each group of plural strands out of the strands surround an aperture of a corresponding one of the meshes. The number of the plural strands surrounding the aperture is four or more. At least one of the plural strands surrounding the aperture has a bent shape or a curved line shape.

### TECHNICAL FIELD

The present disclosure relates to a non-aqueous electrolyte battery.

### BACKGROUND ART

Positive and negative electrodes of a non-aqueous electrolyte battery may have a configuration in which a core material is filled with a mixture containing an active material, a conductive agent, and a binder. PTL 1 discloses a method for manufacturing a positive electrode plate by press-bonding a sheet obtained by molding a positive electrode mixture to a lath core obtained by processing a stainless steel plate with a thickness of 0.1 mm to have a center-to-center dimension SW of the mesh in a shorter direction of 1.5 mm and a center-to-center dimension LW of the mesh in a longer direction of 3.0 mm.

PTL 2 discloses a rechargeable lead battery with an aqueous electrolyte solution. In this battery, when a lead-tin alloy is processed to expand to obtain a positive electrode grid, a shape of a grid body of the positive electrode grid has a mesh structure in which maximum points and minimum points of continuous curved lines overlap each other to form intersection points. This configuration eliminates an uneven distribution of a strain during the expansion process, prevents microcracks inside the grid that induce corrosion, and prevents local corrosion, thus preventing deterioration of the rechargeable lead battery caused by the local corrosion.

### CITATION LIST

### Patent Literature

PTL 1: Japanese Patent No. 3015579
PTL 2: Japanese Patent Lid-Open Publication No. 07-94190

### SUMMARY OF THE INVENTION

In a non-aqueous electrolyte battery, an electrode (for example, a positive electrode) is often prepared by filling an expanded metal, such as that disclosed in PTL 1, with a mixture containing an active material, a binder, and the like, and then is rolled. The expanded metal is obtained by forming a lot of cuts in a metal plate and stretching these cuts to form a lot of apertures in a mesh shape with, e.g. a diamond shape.

The filling and rolling the mixture is often performed along a shorter direction (a SW direction) of the expanded metal. At this moment, a stress, such as a tensile stress or compression, is applied to the expanded metal, increases a distance in the shorter direction of the expanded metal, and decreases a distance in a longer direction (a LW direction) of the expanded metal, so that the entire frame portion deforms.

Expansion of the expanded metal basically depends on material physical properties of a base material that constitutes the expanded metal. When a stress during the filling and the rolling is applied more than the expansion of the base material, the base material in the SW direction may be excessively stretched and may break. This may resultantly deteriorate a current collecting property of the electrode, accordingly deteriorating battery performance, such as discharge performance.

A non-aqueous electrolyte battery according to an aspect of the present disclosure includes a positive electrode, a negative electrode, a separator interposed between the positive electrode and the negative electrode, and a non-aqueous electrolyte. The positive electrode includes a positive electrode active material and an expanded metal. The expanded metal includes a frame portion constituting meshes. The frame portion includes strands and bonds connecting the strands to one another. Each group of plural strands out of the strands surround an aperture of a corresponding one of the meshes. The number of the plural strands surrounding the aperture is four or more. At least one of the plural strands surrounding the aperture has a bent shape or a curved line shape.

According to the present disclosure, a non-aqueous electrolyte battery having a high energy density and high discharge performance can be realized.

### BRIEF DESCRIPTION OF DRAWINGS

FIG. 1 is a schematic diagram of an example of a current collector made of an expanded metal.

FIG. 2 is a schematic diagram of an apparatus for manufacturing the expanded metal shown in FIG. 1.

FIG. 3A is a schematic diagram of an example of a curved line shape or a bent shape of a strand.

FIG. 3B is a schematic diagram of an example of a curved line shape or a bent shape of the strand.

FIG. 3C is a schematic diagram of an example of a curved line shape or a bent shape of the strand.

FIG. 3D is a schematic diagram of an example of a curved line shape or a bent shape of the strand.

FIG. 4 is a front view of a partial cross section of a non-aqueous electrolyte battery according to an exemplary embodiment of the present disclosure.

### DESCRIPTION OF EMBODIMENTS

A non-aqueous electrolyte battery according to an exemplary embodiment of the present disclosure includes a positive electrode, a negative electrode, a separator interposed between the positive electrode and the negative electrode, and a non-aqueous electrolyte. The positive electrode includes a positive electrode active material and an expanded metal.

The expanded metal is obtained by forming a lot of cuts provided in a metal plate and stretching the cuts to form a lot of apertures with e.g. diamond shapes in a mesh shape. A mesh of the expanded metal is the mesh. A center-to-center distance in the expanded metal means a distance between the centers of meshes.

The expanded metal includes a frame portion that constitutes meshes. The frame portion includes strands and bonds connecting the strands. Each group of plural strands out of the strands surround an aperture of a corresponding one of the meshes. The number of the plural strands surrounding the aperture is four or more. At least one of the plural strands surrounding the aperture has a bent shape or a curved line shape.

In an expanded metal, a strand often has a straight line shape extending from one bond to another bond. However, in the non-aqueous electrolyte battery according to the present embodiment, at least one of the strands does not has a straight line shape but has a bent shape or a curved line shape. This configuration provides the strand with extensibility. Therefore, in processes for manufacturing a battery, a bent portion or a curved line portion is stretched (or bent) due to a tensile stress or compressive stress applied to the expanded metal in a step of filling an expanded metal with a mixture and then performing rolling to prepare an electrode, thereby preventing the expanded metal from stretching more than a material-based stretchable amount. This prevents deformation and breakage of the entire frame portion of the expanded metal, thus providing a non-aqueous electrolyte battery with a high energy density and high discharge performance preventing a decrease in a current collecting property of the electrode even when dense filling is performed with the mixture.

In PTL 2, the shape of an expanded metal has a curved line shape near the intersection point of the grid bodies. This configuration prevents the uneven distribution of the strain during the expansion process, and prevents occurrence of the microcracks that cause the local corrosion, but grid elongation that occurs during rolling is not considered. Therefore, the invention described in PTL 2 is completely different from the present invention, which aims to prevent breakage due to excessive deformation of the expanded metal during rolling. The prevention of grid body corrosion, which is a problem to be solved by the invention described in PTL 2, is a problem particularly applied to a rechargeable lead battery with the lead-tin alloy for the grid body, and does not present in the non-aqueous electrolyte battery according to the present invention.

The bent shape or the curved line shape of the strand may be a convex shape or a concave shape. Here, upon focusing on a contour line of the mesh having a bent shape or a curved line shape, when the contour line has a convex shape (concave shape) due to the bent shape or the curved line shape, the bent shape or the curved line shape is the convex shape (concave shape).

The bent shape is formed by at least two straight lines. The bent shape may be formed by three or more straight lines. The curved line shape may be formed by plural curved lines. The bent shape or the curved line shape may have, for example, a convex shape and a concave shape, like an undulating curved line shape and a zigzag shape.

### Expanded Metal

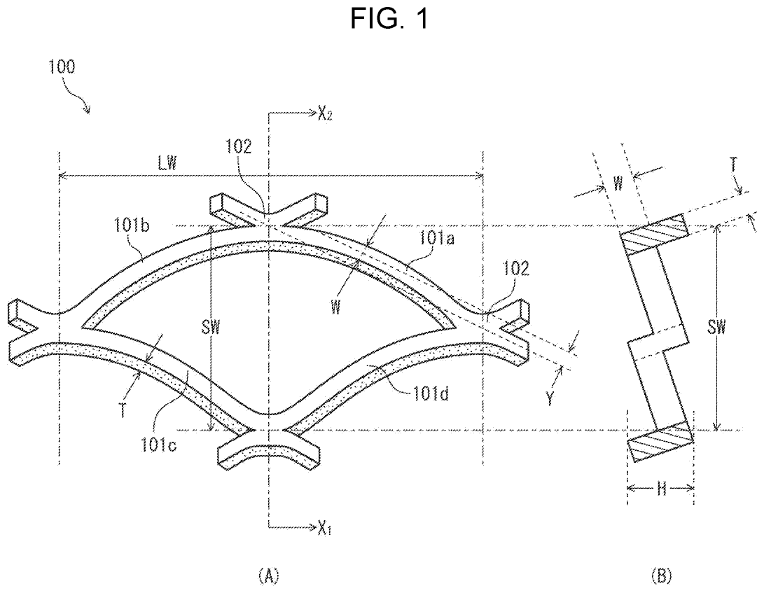

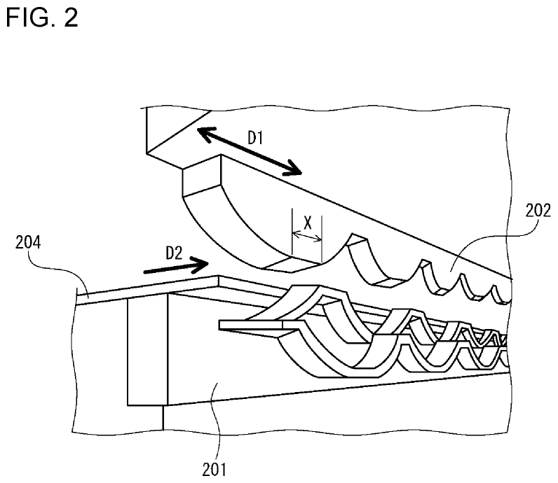

FIG. 1 shows an example of a current collector made of an expanded metal. FIG. 1(A) is a top view thereof and FIG. 1(B) is a cross-sectional view thereof when viewed in an X₁-X₂ direction. T, SW, LW, and W in FIG. 1(A) are referred to as a strand thickness T, a center-to-center distance SW in a shorter direction, a center-to-center distance LW in a longer direction, and a feed width W of the expanded metal, respectively. Expanded metal 100 shown in FIG. 1 may be prepared, for example, by processing a metal plate with a manufacturing apparatus shown in FIG. 2.

Expanded metal 100 includes four strands 101a to 101d surrounding an aperture of a mesh and bonds 102 connecting the strands to one another. Strands 101a to 101d are processed to have curved line shapes (circular arcuate shapes in the example shown in FIG. 1). In this case, when viewed far away from expanded metal 100, the shape of the mesh is approximated as a diamond shape. However, the shape of the mesh is strictly not a diamond shape, but a curved line surrounded by four circular arcs. A curvature radius of each of the four circular arcs is not particularly limited, and may be, for example, 1 mm to 4 mm.

Since the strand has a bent shape or a curved line shape, the stress applied to the expanded metal during the battery manufacturing step is relieved by expanding a portion having a bent shape or a curved line shape, and/or by applying a bending stress to the portion having a bent shape or a curved line shape to bend the portion having a bent shape or a curved line shape. This configuration provides the non-aqueous electrolyte battery with a high energy density and high discharge performance which prevents excessive expansion and breakage of a core material.

Strands 101a and 101c out of strands 101a to 101d extend substantially in a first direction as a whole while the extension direction depends on positions on the curved line shape. Strands 101b and 101d extend substantially in a second direction intersecting the first direction as a whole while the extension direction depends on positions on the curved line shape. The first direction and the second direction are parallel to a straight line connecting bonds 102 to each other. Strands 101a and 101c have the same curved line shape. When strand 101a is translated in the second direction, strand 101a overlaps strand 101c. Strands 101b and 101d have the same curved line shape. When strand 101b is translated in the first direction, strand 101b overlaps strand 101d.

Expanded metal manufacturing apparatus 200 shown in FIG. 2 includes lower blade 201 and upper blade 202 which extend in first direction D1 parallel to a main surface of metal plate 204. Upper blade 202 is movable in upward and downward directions (directions perpendicular to metal plate 204). Upon moving in a downward direction from the position shown in FIG. 2, upper blade 202 forms cuts in metal plate 204, and expands the cut portions to form meshes. Upper blade 202 is further reciprocatable within a predetermined width in first direction D1. Metal plate 204 is intermittently carried in second direction D2 parallel to the main surface of metal plate 204 and perpendicular to the first direction in conjunction with the up-down movement of upper blade 202. Upper blade 202 moves in first direction D1 in conjunction with the carrying of metal plate 204 in second direction D2. Accordingly, the cuts are formed in metal plate 204 alternately at a predetermined interval, and the cut portions are expended along upper blade 202 to form meshes with diamond shapes.

Upper blade 202 has a curved line shape. Accordingly, the strands are processed to have a shape having corresponding curved line shapes.

Strand thickness T of the expanded metal is a thickness of metal plate 204 before processing shown in FIG. 2. Feed width W is substantially equal to the interval between the cuts. Center-to-center distance SW in a shorter direction corresponds to a length of a shorter diagonal line of the diamond-shaped mesh. Center-to-center distance LW in a longer direction is a length of a longer diagonal line of the diamond-shaped mesh.

In the example shown in FIG. 1, each strand has a curved line shape (circular arcuate shape). The curved line shape is not limited to a circular arc, and may be any curved line shape. Due to the portion having a curved line shape, a contour of the mesh (aperture) has a convex portion or a concave portion. The curved line shape may be formed by curved lines having different curvatures. The curved line shape may be a shape having a convex portion and a concave portion, such as an undulating shape or an S shape.

Each strand may have a bent shape. The bent shape is composed of at least two straight lines. The bent shape may be composed of three or more straight lines. Similar to the curved line shape, the bent shape may have, for example, a shape having a convex shape and a concave shape, like a meandering shape.

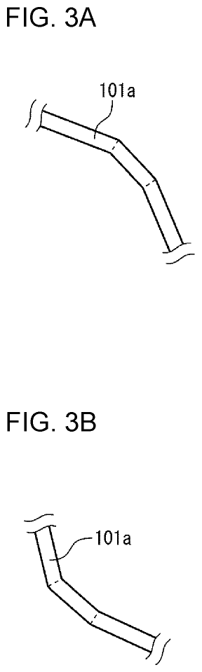

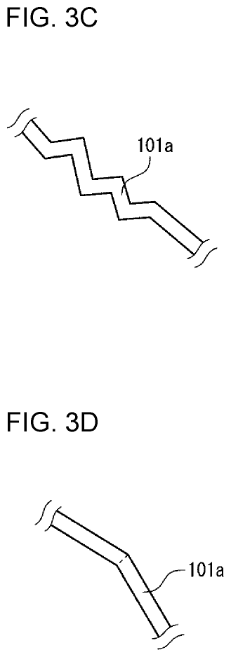

FIG. 3 shows other examples of the curved line shape or the bent shape of the strand. FIGS. 3A to 3D show examples in which strand 101a in FIG. 1 with a portion having a bent shape. The bent shape may be a convex shape composed of three straight lines, as shown in FIG. 3A, or a concave shape composed of three straight lines, as shown in FIG. 3B. The bent shape may also have a meandering shape having plural straight lines, as shown in FIG. 3C. As shown in FIG. 3D, the convex shape of the strand may be composed of two straight lines.

Center-to-center distance SW in a shorter direction and center-to-center distance LW in a longer direction of the expanded metal may preferably satisfy 2 mm²≤LW·SW≤20 mm², and more preferably satisfy 6 mm²≤LW·SW≤20 mm². LW·SW of 2 mm² or more allows a positive electrode active material layer to be formed by press-bonding without gaps while reducing a variation in a density of the positive electrode active material. Therefore, non-uniformity of a battery reaction (for example, a discharge reaction) within an electrode plate is prevented, and the discharge performance of the battery is improved.

For example, in a case where two positive electrode mixture sheets are press-bonded from both sides so as to sandwich the expanded metal to prepare a positive electrode, LW·SW of less than 2 mm² may cause the sheets to be hardly press-bonded to each other and cause the density of the positive electrode mixture layer to be uneven. Specifically, the positive electrode mixture has a density increasing locally at a surface of the positive electrode, hardly absorbing the electrolyte solution. As a result, although the battery reaction progresses in the vicinity of the surface, it is difficult for the reaction to progress to the inside of the positive electrode mixture layer, and the battery reaction may not be performed uniformly. However, LW·SW of 2 mm² or more allows the reaction to progress uniformly and maintains a high discharge characteristic.

On the other hand, as LW·SW increases, a distance from the positive electrode active material to the expanded metal at the center position of the mesh increases, and the current collecting property may decrease. In order to prevent the decrease in the current collecting property, LW·SW is preferably 20 mm² or less.

SW and LW may be selected such that LW·SW is 2 mm² or more and 20 mm² or less (more preferably 6 mm² or more and 20 mm² or less).

The thickness of the positive electrode is 0.3 mm or more and preferably 3 mm or less. The thickness of the positive electrode is more preferably 0.8 mm or more and 3 mm or less. As the thickness of the positive electrode increases, a larger pressure is applied to the expanded metal during the filling, so that a stretching effect of the expanded metal according to the present invention is exhibited. The thickness of the positive electrode of 3 mm or less prevents a distance from the expanded metal to an outermost surface of the electrode from being excessively long, accordingly preventing the decrease in the current collecting property.

The expanded metal having small strand thickness T or small feed width W of the expanded metal may cause the core material portion (frame) to break when press-bonding the positive electrode mixture. This may increase an electrical resistance and decrease the current collecting property. On the other hand, the expanded metal having larger strand thickness T or large feed width W prevents the breakage of the core material portion (frame) upon press-bonding of the positive electrode mixture. However, the expanded metal having large strand thickness T or large feed width W increases rigidity of the expanded metal, hardly allowing the electrodes to be rolled prepare an electrode group.

Strand thickness T is preferably 0.1 mm or more, and more preferably 0.15 mm or more in order to prevent the frame of the expanded metal from becoming too thin, to prevent the expanded metal from breaking when press-bonding the positive electrode mixture, and to maintain a small electrical resistance. On the other hand, excessively large strand thickness T increases its rigidity, hardly allowing the expanded metal to be processed and hardly allowing the electrode plate to be rolled to prepare an electrode group (a wound body). In order to facilitate the processing of the expanded metal and the production of the wound body, strand thickness T is preferably 0.3 mm or less.

Feed width W is preferably 0.13 mm or more, and more preferably 0.15 mm or more in order to prevent the frame of the expanded metal from becoming too thin, to prevent the expanded metal from breaking when press-bonding the positive electrode mixture, and to maintain the electrical resistance low. On the other hand, excessively large feed width W increases its rigidity, hardly allowing the electrode plate to be rolled to prepare an electrode group (wound body). Large height H of the expanded metal hardly allows the expanded metal to be uniformly with the positive electrode mixture. In order to facilitate the production of the wound body and to prevent a density difference of the positive electrode mixture in the electrode plate, feed width W is preferably 0.3 mm or less.

Ratio T/W of strand thickness T to feed width W is preferably 0.3 or more and 2.4 or less, more preferably 0.5 or more and 2 or less, and still more preferably 0.7 or more and 1.5 or less. Ratio T/W less than 0.3 increases a size of a joint portion of the expanded meta, preventing the positive electrode mixture from adhering securely to the joint portion and allowing the positive electrode mixture to tend to have a density difference. In addition, the expanded metal tends to be expanded in a longer direction during press-bonding. This may allow a grid shape to deform and decrease current collecting efficiency. On the other hand, ratio T/W greater than 2.4 increases the thickness of the strand, preventing from being sufficiently filled with the positive electrode mixture and allowing the density difference of the positive electrode mixture. Ratio T/W in the range of 0.3 or more and 2.4 or less allows the expanded metal to be unfirmly filled with the positive electrode mixture, and prevents non-uniformity of the battery reaction.

Height H of the expanded metal may be 0.5 mm or less. Height H of 0.5 mm or less prevents exposure of the expanded metal when press-bonding the positive electrode mixture. Height H may be reduced by rolling or stretching the expanded metal after processing.

Height H of the expanded metal refers to, when the expanded metal is placed on a flat surface, a maximum distance from an outer surface of the expanded metal to the flat surface. In general, height H is a distance between two parallel planes tangent to the bond of the expanded metal from the outside. In the example in FIG. 1, length H in FIG. 1(B) is height H of the expanded metal.

When the expanded metal after processing is rolled, height H may be obtained by cutting the expanded metal or the electrode plate and analyzing a contour shape of the expanded metal on a cut surface.

When SW is 1 mm or more, 1.5≤LW/SW≤3 may be satisfied. This configuration reduces anisotropy of the electrical resistance in the expanded metal, and provides high battery performance.

In the expanded metal, for example, strand thickness T of the expanded metal may satisfy 0.1 mm≤T≤0.3 mm, SW and LW may satisfy 2 mm²≤LW·SW≤20 mm², and feed width W of the expanded metal may satisfy 0.13 mm≤W≤0.3 mm. Even if the thickness of the positive electrode is 0.8 mm or more, this configuration provides the high battery performance (for example, discharge performance) and a high energy density with a wound electrode group.

The expanded metal may be produced by processing the metal plate as described above, for example, with the apparatus shown in FIG. 2. Examples of the metal plate include a stainless steel, aluminum, nickel, and titanium plate. A stainless steel, such as SUS444, SUS430, SUS304, and SUS316, out of the examples is preferable. A tensile strength of the metal plate is not particularly limited, and may range, e.g. from 400 N/mm² to 550 N/mm².

The tensile strength of the metal plate greater than 550 N/mm² may cause the metal plate to partially break against the expansion of the expanded metal. In addition, this may increase the density difference of the positive electrode mixture. On the other hand, the tensile strength of the metal plate less than 400 N/mm² may cause the expanded metal to be expandable and to be prevented from breaking. However, this configuration may cause the density and the thickness of the positive electrode mixture to be controlled. In contrast, the tensile strength ranging from 400 N/mm² to 550 N/mm² allows the expanded metal to moderately expand to prevent the breakage of the expanded metal, and allows the density and the thickness of the positive electrode mixture to be easily controlled.

The expanded metal after processing may be subjected to a heat treatment (annealing treatment). The annealing reduces a Young's modulus of the expanded metal, consequently allowing an electrode plate group to be easily rolled to prepare an electrode body.

A Vickers hardness of the metal plate is preferably 230 HV or less, and more preferably 160 HV or less. The Vickers hardness of the metal plate of 230 HV or less allows the electrode plate to be wound to obtain an electrode group having a high roundness, and prevents non-uniformity in a charge and discharge reaction. The Vickers hardness of 160 HV or less enhances uniformity of the charge and discharge reaction (especially the discharge reaction), maintains and the high discharge characteristic even at a large discharge depth exceeding 90%.

A material of the metal plate may be a stainless steel from a viewpoint that the Vickers hardness can be easily reduced. When using a stainless steel, an austenitic stainless steel (SUS304, SUS316, or the like) is preferable to a ferritic stainless steel (SUS430, SUS444, or the like). For an expanded metal prepared by processing an austenitic stainless steel, it is easy to reduce the Vickers hardness to 160 HV or less by a heat treatment (annealing).

In the example in FIG. 1, the shape of the mesh of the expanded metal may be approximated to a diamond shape, but such a shape may be a polygonal shape having more than four strands. For example, in the apparatus in FIG. 2, by increasing width X of peaks and valleys of upper blade 202, an expanded metal with hexagonal meshes each having six strands surrounding each aperture manufactured. It is sufficient that at least one of the six strands has a bent shape or a curved surface shape.

The shape of the mesh of the expanded metal after the completion of the battery may be a deformed bent shape or curved line shape due to the stretching of the strand. The strand may be stretched to have a substantially straight line shape. The shape of the strand of the expanded metal may be approximated to a diamond shape as the strand is stretched, but may be approximated to a polygonal shape (for example, a hexagonal shape). The shape of the meshes of the expanded metal may be obtained from an image obtained by imaging the frame portion and the strands of the expanded metal by performing transmission on the battery using an X-ray transmission device. Values of SW and LW may be obtained by measuring dimensions from the image.

### Positive Electrode Active Material/Positive Electrode Mixture Layer

The positive electrode active material may be contained in the positive electrode mixture layer together with a conductive agent and/or a binder. The density of the positive electrode mixture layer is preferably 2.4 g/cm³ or more and 3.2 g/cm³ or less. The density of the positive electrode mixture layer of 2.4 g/cm³ or more enhances a binding property of the positive electrode mixture layer, prevents expansion of the electrode plate due to charge and discharge, and maintains a high capacity. On the other hand, as the density of the positive electrode mixture layer increases, a higher pressure is required to press-bond the positive electrode mixture to the expanded metal, and the expanded metal tends to break. However, the density of the positive electrode mixture layer of 3.2 g/cm³ or less prevents the breakage of the expanded metal during press-bonding. From a viewpoint of a battery capacity, the density of the positive electrode mixture layer is preferably 2.8 g/cm³ or more and 3.2 g/cm³ or less, and in this case, effects of the present invention are remarkable.

An average particle diameter of the positive electrode active material filling the expanded metal may range from 15 μm to 80 μm, or from 30 μm to 60 μm. The average particle diameter of the positive electrode active material of 15 μm or more allows a large amount of the conductive auxiliary agent to adhere to positive electrode active material particles, and enhances electrical connection with the expanded metal through the conductive auxiliary agent. Therefore, the current collecting property can be improved, and the charge and discharge performance can be improved. For example, a voltage drop during pulse discharge can be prevented. On the other hand, an excessively large average particle diameter of the positive electrode active material, that is, excessively large particles decrease the mixture density, and cause the conductive auxiliary agent to be unevenly distributed in gaps between the particles. The average particle diameter of 80 μm or less prevents the decrease in the mixture density and the decrease in the current collecting property.

The average particle diameter of the positive electrode active material is calculated by measuring in a particle state or an electrode state.

In the particle state, the positive electrode active material alone is extracted or the positive electrode active material is extracted from the mixture to obtain, as the average particle diameter, a median diameter (D50) of a particle diameter at which a cumulative frequency is 50% in a volume-based particle size distribution measured by a quantitative laser diffraction method. Alternatively, for plural (for example, 100 or more) active material particles under an optical microscope, a median value may be obtained by particle size distribution measurement using a circle equivalent diameter, a major axis diameter, a minor axis diameter, a biaxial average diameter, and a circumscribed rectangle equivalent diameter.

In the electrode state, the average particle diameter may be calculated by taking out the positive electrode from the battery, cutting the positive electrode to prepare a cross section of the positive electrode mixture layer, and observing the cross section with a scanning electron microscope. A magnification is set such that 10 or more active material particles are included in one field of view, a grain boundary of the positive electrode active material is obtained by image analysis of a cross-sectional photograph, and particle size distribution measurement is performed using a diameter of a circle (equivalent circle) equal to an area of the particles in the cross section, thereby obtaining a median value as the average particle diameter. The measurement is preferably performed by measuring a total of 100 particles or more in multiple fields of view.

The present disclosure can be applied to any non-aqueous electrolyte battery in which the expanded metal is used in the current collector, regardless of whether the battery is a primary battery or a secondary battery, and regardless of the configurations of the positive electrode and the negative electrode. In particular, when the present disclosure is applied to a lithium primary battery containing at least one of metallic lithium and a lithium alloy in the negative electrode, a battery having a high capacity and an excellent discharge characteristic can be realized. A structure of the non-aqueous electrolyte battery may be a cylindrical battery including a wound electrode group formed by spirally winding a strip-shaped positive electrode and a strip-shaped negative electrode with a separator interposed therebetween, or may be a flat plate type battery or a coin type battery including a single-layer electrode configuration or a laminated electrode configuration in which a strip-shaped positive electrode and a strip-shaped negative electrode are laminated with a separator.

The battery according to the present disclosure is not particularly limited as long as it is a non-aqueous electrolyte battery. Hereinafter, the non-aqueous electrolyte battery according to the present embodiment will be described more specifically by taking a cylindrical lithium primary battery as an example.

### Lithium Primary Battery

### Positive Electrode

The positive electrode may include a positive electrode mixture layer and a positive electrode current collector that holds the positive electrode mixture layer. The positive electrode current collector includes an expanded metal. The positive electrode mixture layer is obtained by, for example, pressing, in a thickness direction, a wet positive electrode mixture prepared by adding an appropriate amount of water to a positive electrode active material and an additive to fill meshes of the expanded metal, and then drying it.

Examples of the positive electrode active material contained in the positive electrode include manganese dioxide. A positive electrode containing manganese dioxide develops a relatively high voltage and has an excellent pulse discharge characteristic. Manganese dioxide may be in a mixed crystal state including plural crystal states. The positive electrode may contain manganese oxides other than manganese dioxide. Examples of the manganese oxides other than manganese dioxide include MnO, Mn₃O₄, Mn₂O₃, and Mn₂O₇. A main component of the manganese oxides contained in the positive electrode is preferably manganese dioxide.

Part of manganese dioxide contained in the positive electrode may be doped with lithium. When a doping amount of lithium is small, a high capacity can be secured. Manganese dioxide and manganese dioxide doped with a small amount of lithium may be represented by LiₓMnO₂ (0<x≤0.05). An average composition of all manganese oxides contained in the positive electrode is LiₓMnO₂ (0<x≤0.05). Ratio x of Li is 0.05 or less in an initial state of discharge of the lithium primary battery. Ratio x of Li generally increases as the discharge of the lithium primary battery progresses. An oxidation number of manganese contained in manganese dioxide is theoretically tetravalent. However, when other manganese oxides are contained in the positive electrode or manganese dioxide is doped with lithium, the oxidation number of manganese may decrease from tetravalent. Therefore, in LiₓMnO₂, an average oxidation number of manganese may be slightly smaller than tetravalent.

The positive electrode may contain other positive electrode active materials used in lithium primary batteries. Examples of the other positive electrode active materials include graphite fluoride. A proportion of LiₓMnO₂ in the entire positive electrode active material may be 90 mass % or more.

As manganese dioxide, electrolytic manganese dioxide is preferably used. Electrolytic manganese dioxide that has been subjected to at least one treatment of a neutralization treatment, a washing treatment, and a calcination treatment may be used as necessary. Electrolytic manganese dioxide is generally obtained by electrolysis of a manganese sulfate aqueous solution.

By adjusting conditions during electrolytic synthesis, crystallinity of manganese dioxide can be increased, and a specific surface area of electrolytic manganese dioxide can be reduced. ABET specific surface area of LiₓMnO₂ may be 10 m²/g or more and 50 m²/g or less. The BET specific surface area of LiₓMnO₂ within this range, in the lithium primary battery, prevents the voltage drop during pulse discharge, provides a higher effect of preventing self-discharge, and prevents gas generation. In addition, the positive electrode mixture layer may be easily formed.

The BET specific surface area of LiₓMnO₂ may be measured by a known method, and for example, is measured based on a BET method with a specific surface area measuring apparatus (for example, manufactured by MOUNTECH Co., Ltd.). For example, LiₓMnO₂ separated from the positive electrode taken out from the battery may be used as a measurement sample.

A median value of particle diameters of LiₓMnO₂ may be 15 μm or more and 80 μm or less. The median value of particle diameters (median diameter D50) within such a range allows LiₓMnO₂, which is the positive electrode active material, to be connected to the current collector (expanded metal) via a large amount of conductive agent to enhance the current collecting property. In addition, this configuration prevents the decrease in the mixture density, the uneven distribution of the conductive agent in the gaps between the particles, and the decrease in the current collecting property. The discharge performance is thus enhanced, and prevents the voltage drop during pulse discharge.

The median value of particle diameters of LiₓMnO₂ is, for example, a median value in a particle size distribution obtained by a quantitative laser diffraction method (qLD method). For example, LiₓMnO₂ separated from the positive electrode taken out from the battery may be used as a measurement sample. For the measurement, for example, SALD-7500nano manufactured by Shimadzu Corporation is used.

The positive electrode mixture may contain a binder in addition to the positive electrode active material. The positive electrode mixture may contain a conductive agent.

Examples of the binder include a fluorine resin, rubber particles, and an acrylic resin.

Examples of the conductive agent include a conductive carbon material. Examples of the conductive carbon material include natural graphite, artificial graphite, carbon black, and a carbon fiber.

### Negative Electrode

The negative electrode may contain metallic lithium or a lithium alloy, or may contain both metallic lithium and a lithium alloy. For example, a composite containing metallic lithium and a lithium alloy may be used for the negative electrode.

Examples of the lithium alloy include a Li—Al alloy, a Li—Sn alloy, a Li—Ni—Si alloy, and a Li—Pb alloy. A content of metal elements other than lithium contained in the lithium alloy is preferably 0.05 mass % to 15 mass % from a viewpoint of securing a discharge capacity and stabilizing an internal resistance.

Metallic lithium, the lithium alloy, or the composite thereof may be molded into a shape and a thickness according to a shape, dimension, standard performance, and the like of the lithium primary battery.

A sheet of metallic lithium, the lithium alloy, or the composite thereof may be used for the negative electrode. The sheet is obtained by, for example, extrusion molding. More specifically, in a cylindrical battery, a metallic lithium foil, a lithium alloy foil or the like, which has a shape having a longitudinal direction and a lateral direction, is used.

In the cylindrical battery, along tape including a resin base material and an adhesive layer may be attached onto at least one main surface of the negative electrode along the longitudinal direction. The main surface is a surface facing the positive electrode. A width of this tape is preferably, for example, 0.5 mm or more and 3 mm or less. This tape prevents occurrence of current collection failure due to foil breakage of the negative electrode when a lithium component of the negative electrode is consumed by a reaction at the end of discharge.

As a material of the resin base material, for example, a fluorine resin, a polyimide, a polyphenylene sulfide, a polyethersulfone, a polyolefin such as polyethylene and polypropylene, and polyethylene terephthalate can be used. Among these, a polyolefin is preferable, and polypropylene is more preferable.

The adhesive layer contains, for example, at least one component selected from the group consisting of a rubber component, a silicone component, and an acrylic resin component. Specifically, as the rubber component, a synthetic rubber, a natural rubber, or the like can be used. Examples of the synthetic rubber include a butyl rubber, a butadiene rubber, a styrene-butadiene rubber, an isoprene rubber, neoprene, polyisobutylene, an acrylonitrile-butadiene rubber, a styrene-isoprene block copolymer, a styrene-butadiene block copolymer, and a styrene-ethylene-butadiene block copolymer. As the silicone component, an organic compound having a polysiloxane structure, a silicone-based polymer, or the like can be used. Examples of the silicone-based polymer include a peroxide-curable silicone and an addition-reactive silicone. As the acrylic resin component, a polymer containing an acrylic monomer such as acrylic acid, methacrylic acid, an acrylic acid ester, and a methacrylic acid ester can be used. Examples of the acrylic resin component include a homopolymer or copolymer of an acrylic monomer such as acrylic acid, methacrylic acid, methyl acrylate, methyl methacrylate, ethyl acrylate, ethyl methacrylate, propyl acrylate, propyl methacrylate, butyl acrylate, butyl methacrylate, octyl acrylate, octyl methacrylate, 2-ethylhexyl acrylate, and 2-ethylhexyl methacrylate. The adhesive layer may contain a cross-linking agent, a plasticizer, and a tackifier.

### Electrolyte

As the electrolyte (non-aqueous electrolyte), for example, a non-aqueous electrolyte solution obtained by dissolving a lithium salt or lithium ions in a non-aqueous solvent can be used.

### Non-Aqueous Solvent

Examples of the non-aqueous solvent include an organic solvent that is generally used in a non-aqueous electrolyte solution for a lithium primary battery. Examples of the non-aqueous solvent include an ether, an ester, and a carbonate ester. As the non-aqueous solvent, dimethyl ether, γ-butyrolactone, propylene carbonate, ethylene carbonate, 1,2-dimethoxyethane, or the like can be used. The non-aqueous electrolyte solution may contain one non-aqueous solvent, or may contain two or more non-aqueous solvents.

From a viewpoint of improving the discharge characteristic of the lithium primary battery, the non-aqueous solvent preferably contains a cyclic carbonate ester having a high boiling point and a chain ether having a low viscosity even at a low temperature. The cyclic carbonate ester preferably contains at least one selected from the group consisting of propylene carbonate (PC) and ethylene carbonate (EC), and particularly preferably contains PC. The chain ether preferably has a viscosity of 1 mPa s or less at 25° C., and particularly preferably contains dimethoxyethane (DME). The viscosity of the non-aqueous solvent can be obtained by measurement performed using a trace sample viscometer m-VROC manufactured by Rheosense Inc. at a temperature of 25° C. and a shear rate of 10000 (1/s).

### Lithium Salt

The non-aqueous electrolyte solution may contain a lithium salt other than cyclic imide components. Examples of the lithium salt include a lithium salt used as a solute in a lithium primary battery. Examples of such a lithium salt include LiCF₃SO₃, LiN(CF₃SO₂)₂, LiClO₄, LiBF₄, LiPF₆, LiRaSO₃ (Rₐ is a fluorinated alkyl group having 1 to 4 carbon atoms), LiFSO₃, LiN(SO₂R_{b})(SO₂R_{c}) (R_{b} and R_{c} are each independently a fluorinated alkyl group having 1 to 4 carbon atoms), LiN(FSO₂)₂, LiPO₂F₂, LiB(C₂O₄)₂, and LiBF₂(C₂O₄). The non-aqueous electrolyte solution may contain one of these lithium salts, or two or more thereof.

### Others

A concentration of lithium ions contained in the electrolyte solution (total concentration of lithium salts) ranges, for example, from 0.2 mol/L to 2.0 mol/L, and may range from 0.3 mol/L to 1.5 mol/L.

The electrolyte solution may contain additives, as necessary. Examples of such additives include propane sultone and vinylene carbonate. A total concentration of such additives contained in the non-aqueous electrolyte solution ranges, for example, from 0.003 mol/L to 5 mol/L.

### Separator

The lithium primary battery generally includes a separator interposed between the positive electrode and the negative electrode. The separator may be made of a porous sheet formed of an insulating material that is resistant to an internal environment of the lithium primary battery. Specific examples of the porous sheet include a synthetic resin-made nonwoven fabric, a synthetic resin-made microporous membrane, and a laminate thereof.

Examples of a synthetic resin used for the nonwoven fabric include polypropylene, polyphenylene sulfide, and polybutylene terephthalate. Examples of a synthetic resin used for the microporous membrane include a polyolefin resin such as polyethylene, polypropylene, and an ethylene-propylene copolymer. The microporous membrane may contain inorganic particles, if necessary.

A thickness of the separator is, for example, 5 μm or more and 100 μm or less.

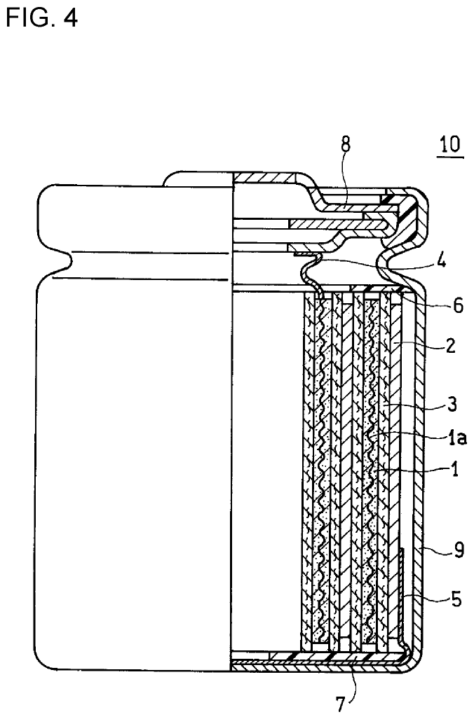

FIG. 4 is a front view of a partial cross section of a cylindrical lithium primary battery according to an exemplary embodiment of the present disclosure. In lithium primary battery 10, an electrode group obtained by winding positive electrode 1 and negative electrode 2 with separator 3 interposed therebetween is accommodated in battery case 9 together with a non-aqueous electrolyte (not shown). Sealing plate 8 is mounted to an opening of battery case 9. Positive electrode lead 4 connected to current collector 1a of positive electrode 1 is connected to sealing plate 8. Negative electrode lead 5 connected to negative electrode 2 is connected to case 9. In addition, upper insulating plate 6 and lower insulating plate 7 are disposed above and below the electrode group to prevent an internal short circuit, respectively.

### EXAMPLES

Hereinafter, the present disclosure will be specifically described below based on Examples and Comparative Examples, but the present disclosure is not limited to the following Examples.

### Batteries A1 to A3

### (1) Preparation of Positive Electrode

100 parts by mass of electrolytic manganese dioxide was mixed with 5 parts by mass of Ketjen black, i.e., a conductive agent, and 5 parts by mass of polytetrafluoroethylene, i.e., a binder, and an appropriate amount of pure water were added and kneaded to prepare a wet positive electrode mixture.

An expanded metal was prepared as a positive electrode current collector. The expanded metal was made of a stainless steel (SUS316). After processing, the expanded metal was subjected to a heat treatment (annealing) at 1000° C. for 10 minutes in a reducing atmosphere.

An expanded metal had a center-to-center distance SW in a shorter direction of 2 mm, a center-to-center distance LW in a longer direction of 4 mm, and a substantially diamond-shaped mesh aperture formed by four bonds. However, the sides (strands) of the diamond shape were formed not as straight lines but as curved lines with circular arcuate shapes, and had a shape similar to the shape shown in FIG. 1(A). A maximum separation distance (dimension Y in FIG. 1(A)) from a curved line represented by center lines of the circular arc-shaped strands to a straight line connecting the bonds was 0.2 mm.

Two sets of roll pair including two rolls were prepared. For each set, a positive electrode mixture was added between one pair of rolls to obtain a positive electrode mixture sheet. The obtained two positive electrode mixture sheets were press-bonded from both sides with the expanded metal interposed therebetween and dried to obtain a positive electrode precursor. After that, the positive electrode precursor was rolled with another pair of rolls to obtain a positive electrode having a predetermined positive electrode mixture density. The thickness of the positive electrode after rolling was 0.8 mm.

Then, the positive electrode was cut into strips each having a width of 42 mm and having a short-side direction of the expanded metal as a longitudinal direction, then part of the filled positive electrode mixture was peeled off, and a SUS316-made tab lead was resistance-welded to a portion where the positive electrode current collector was exposed.

### (2) Preparation of Negative Electrode

A negative electrode was obtained by cutting a metallic lithium foil into strips each having a predetermined size (width is 40 mm). A tab lead made of nickel was connected to a predetermined portion of the negative electrode by pressure welding.

### (3) Preparation of Electrode Group

The positive electrode and the negative electrode were stacked with a separator interposed therebetween, and wound along a winding core having a diameter of 4 mm with a direction parallel to a long-side direction of the expanded metal being an axis to prepare an electrode group. A microporous membrane, which had a thickness of 25 μm and was made of polyethylene, was used as the separator.

### (4) Preparation of Non-Aqueous Electrolyte

PC and DME were mixed at a volume ratio of 4:6. LiCF₃SO₃ was dissolved in the resulting mixture to a concentration of 0.5 mol/L to prepare a non-aqueous electrolyte.

### (5) Assembling of Lithium Primary Battery

A bottomed cylindrical battery case, which had a predetermined size and was made of a nickel-plated steel sheet, was prepared. The electrode group was inserted into the battery case in a state where a ring-shaped lower insulating plate was disposed on a bottom of the electrode group. After that, the tab lead of the positive electrode was connected to an inner surface of a sealing plate, and the tab lead of the negative electrode was connected to an inner bottom surface of the battery case.

Next, the non-aqueous electrolyte was put into the battery case, an upper insulating plate was placed above the electrode group, and then the aperture portion of the battery case was sealed with the sealing plate. After that, each battery was pre-discharged such that the battery voltage was 3.2 V. In this way, a test lithium primary battery (diameter: 17 mm, height: 50 mm) having a rated capacity of 3 Ah, as shown in FIG. 3, was completed.

The average particle diameter (median value D50) of MnO₂ contained in the positive electrode was 25 μm.

Batteries A1 to A3 having different densities of the positive electrode mixture were prepared by changing the thickness of the positive electrode precursor and the pressure during rolling in the preparation of the positive electrode. In battery A1, the positive electrode mixture density was 2.6 g/cm³. In battery A2, the positive electrode mixture density was 2.8 g/cm³. In battery A3, the positive electrode mixture density was 3.0 g/cm³.

Lithium primary batteries A1 to A3 for testing were prepared and was evaluated by the following method.

### (6) Evaluation

Each of the lithium primary batteries immediately after assembly was discharged at a pulse current of 500 mA for 1 second, and a battery voltage V₁ after pulse discharge was measured. The discharge was performed in an environment of 25° C.

### Batteries B1 to B3

In preparation of a positive electrode, an expanded metal having substantially meshes having apertures substantially with diamond shapes formed by four bonds was used, and sides of each diamond shape had substantially a straight line shape. The expanded metal had a center-to-center distance SW in shorter direction of 2 mm and a center-to-center distance LW in longer distance of 4 mm. Lithium primary batteries B1 to B3 for testing were prepared similarly to batteries A1 to A3 except for the above, and were evaluated in the same manner. In battery B1, the density of the positive electrode mixture was 2.6 g/cm³. In battery B2, the density of the positive electrode mixture was 2.8 g/cm³. In battery B3, the density of the positive electrode mixture was 3.0 g/cm³.

Table 1 shows evaluation results of the voltage V₁ after pulse discharge of lithium primary batteries A1 to A3 and B1 to B3. Batteries A1 to A3 are Examples, and batteries B1 to B3 are Comparative Examples. Table 1 further shows the density of a positive electrode mixture in each battery. In each of batteries A1 to A3 and B1 to B3, lengths of the positive electrode and the negative electrode in a longitudinal direction after cutting were adjusted according to the density of the positive electrode mixture such that the battery has a predetermined design capacity. In addition, a thickness of the negative electrode was adjusted such that the negative electrode has a capacity more sufficient than the design capacity of the positive electrode.

According to Table 1, batteries A1 to A3 each including an expanded metal in which the strands have a curved line shape maintains a higher voltage V₁ after pulse discharge than batteries B1 to B3 each including a conventional expanded metal in which the strands have straight line shapes. In addition, no breakage of the expanded metal was observed during the preparation of the positive electrode in batteries A1 to A3.

In the batteries having the density of the positive electrode mixture density of 2.6 g/cm³, the voltage V₁ of battery B1 after pulse discharge was 2.80 V, which was lower than that of battery A1. In the batteries having the density of the positive electrode mixture was 2.8 g/cm³, the voltage V₁ of battery B2 after pulse discharge was 2.50 V, which was significantly lower than that of the battery A2. When examining the positive electrode used in battery B2, it was found that a large force was applied to the expanded metal during rolling of the positive electrode precursor, and the expanded metal was partially broken. In battery B3 in which the positive electrode mixture density was 3.0 g/cm³, the expanded metal had more breakage portions than B2, a wound electrode group could not be prepared, and battery B3 did not function as a battery.

In contrast, in batteries A1 to A3, a high voltage V₁ after pulse discharge of 2.85 V were maintained regardless of the density of the positive electrode mixture.

TABLE 1

| | Density of | |
|---|---|---|
| Lithium | Positive Electrode | Voltage after Pulse |
| Primary Battery | Mixture [g/cm³] | Discharge Vᵢ [V] |
| A1 | 2.6 | 2.85 |
| A2 | 2.8 | 2.85 |
| A3 | 3.0 | 2.85 |
| B1 | 2.6 | 2.80 |
| B2 | 2.8 | 2.50 |
| B3 | 3.0 | — |

### INDUSTRIAL APPLICABILITY

A non-aqueous electrolyte battery according to the present disclosure has a high energy density and high discharge characteristic, and thus is suitably used, for example, as a main power source or a memory backup power source for various meters.

### REFERENCE MARKS IN THE DRAWINGS

1 positive electrode
1a positive electrode current collector
2 negative electrode
3 separator
4 positive electrode lead
5 negative electrode lead
6 upper insulating plate
7 lower insulating plate
8 sealing plate
9 battery case
10 lithium primary battery
100 expanded metal
101a-101d strand
102 bond
200 expanded metal manufacturing apparatus
201 lower blade
202 upper blade
204 metal plate

1. A non-aqueous electrolyte battery comprising:
a positive electrode;
a negative electrode;
a separator interposed between the positive electrode and the negative electrode; and
a non-aqueous electrolyte, wherein
the positive electrode includes a positive electrode active material and an expanded metal,
the expanded metal includes a frame portion having meshes,
the frame portion includes strands and bonds connecting the strands to one another, each group of plural strands out of the strands surrounding an aperture of a corresponding one of the meshes,
a number of the plural strands surrounding the aperture is four or more, and
at least one of the plural strands surrounding the aperture has a bent shape or a curved line shape.

2. The non-aqueous electrolyte battery according to claim 1, wherein a center-to-center distance SW of the expanded metal in a shorter direction and a center-to-center distance LW of the expanded metal in a longer direction satisfy 2 mm²≤LW·SW≤20 mm².

3. The non-aqueous electrolyte battery according to claim 1, wherein
a strand thickness T of the expanded metal satisfies 0.1 mm≤T≤0.3 mm, and
a feed width W of the expanded metal satisfies 0.13 mm≤W≤0.3 mm.

4. The non-aqueous electrolyte battery according to claim 1, wherein a thickness of the positive electrode is 0.3 mm or more and 3 mm or less.

5. The non-aqueous electrolyte battery according to claim 1, wherein the SW is 1 mm or more and satisfies 1.5≤LW/SW≤3.

6. The non-aqueous electrolyte battery according to claim 1, wherein the positive electrode active material contains manganese dioxide.

7. The non-aqueous electrolyte battery according to claim 6, wherein a density of a mixture in the positive electrode is 2.4 g/cm³ or more and 3.2 g/cm³ or less.
